(19) United States
(12) Patent Application Publication
(10) Pub. No.: US 2014/0074953 A1
(43) Pub. Date: Mar. 13, 2014

(54) AUTOMATED E-MAIL SCREENING TO VERIFY RECIPIENTS OF AN OUTGOING E-MAIL MESSAGE

(71) Applicant: International Business Machines Corporation, Armonk, NY (US)

(72) Inventor: William J. Piazza, Holly Springs, NC (US)

(73) Assignee: INTERNATIONAL BUSINESS MACHINES CORPORATION, Armonk, NY (US)

(21) Appl. No.: 14/062,411

(22) Filed: Oct. 24, 2013

Related U.S. Application Data
(63) Continuation of application No. 13/613,186, filed on Sep. 13, 2012.

(51) Int. Cl. H04L 12/58

(52) U.S. Cl. CPC H04L 51/00
USPC 709/206

(57) ABSTRACT

A method and computer program product for implementing the method are disclosed. The method includes obtaining an e-mail message to be sent and an e-mail distribution list containing prospective recipients of the e-mail message. A subject matter type of the e-mail message to be sent is identified, and one or more user attributes for each prospective recipient is obtained. The method further includes referencing a set of predefined exclusions associating user attributes with subject matter types, to identify any prospective recipients from the e-mail distribution list that have a user attribute that the set of predefined exclusions associate with the subject matter type of the e-mail message to be sent. The e-mail message is sent to the e-mail distribution list except for the prospective recipients identified using the set of predefined exclusions.

### CROSS-REFERENCE TO RELATED APPLICATIONS

This application is a continuation of U.S. patent application Ser. No. 13/613,186 filed on Sep. 13, 2012, which application is incorporated by reference herein.

### BACKGROUND OF THE INVENTION

1. Field of the Invention

The present invention relates generally to electronic mail, and more particularly to systems and methods for controlling which recipients are to receive an e-mail message.

2. Background of the Related Art

Electronic mail (e-mail) has become a predominant mode of communication, in part due to the ease of creating and editing electronic documents and sending those documents quickly. The ability to send a message to a large number of users electronically, without the labor and expense of individually mailing physical documents, has fostered the use of bulk e-mail, which may be sent to a large number of recipients. Businesses, schools, and other organizations now rely on e-mail messages for routine communications in bulk. For example, a university may send routine notices to a large number of students by e-mail, such as to acknowledge the receipt of application materials and to notify applicants of the progress of an application for admission. Usually, a form letter is generated for such communications, and the form letter can be sent by e-mail in bulk to a distribution list identifying the e-mail addresses of the intended recipients.

### BRIEF SUMMARY OF THE INVENTION

According to one method, an e-mail message to be sent is obtained along with an e-mail distribution list containing prospective recipients of the e-mail message. A subject matter type of the e-mail message to be sent is identified. One or more user attributes are obtained for each prospective recipient. A set of predefined exclusions are referenced that associate the user attributes with the subject matter types, to identify any of the prospective recipients from the e-mail distribution list that are excluded by the subject matter type of the e-mail message to be sent. The e-mail message may then be sent to the e-mail distribution list except for the prospective recipients that are excluded by the subject matter type of the e-mail message.

Another embodiment of the present invention provides a computer program product including computer usable program code embodied on a computer usable medium for screening an e-mail distribution list. The computer program product includes computer usable program code for obtaining an e-mail message to be sent and an e-mail distribution list containing prospective recipients of the e-mail message; computer usable program code for identifying a subject matter type of the e-mail message to be sent; computer usable program code for obtaining one or more user attributes for each prospective recipient; computer usable program code defining a set of exclusions associating user attributes with subject matter types; computer usable program code for referencing the set of exclusions to identify any prospective recipients from the e-mail distribution list that are excluded by the subject matter type of the e-mail message to be sent; and computer usable program code for sending the e-mail message to the e-mail distribution list except for the prospective recipients excluded by the subject matter type of the e-mail message.

### BRIEF DESCRIPTION OF THE SEVERAL VIEWS OF THE DRAWINGS

FIG. 1 is a schematic diagram of an e-mail screening system for automatically screening a distribution list in view of the content of an outgoing e-mail message before sending the e-mail message.

FIG. 2 is a flowchart generally outlining a method of screening a distribution list prior to sending an e-mail message to selectively exclude prospective recipients from being sent the e-mail message.

FIG. 3 is a flowchart outlining an example method for generating subject matter types for characterizing an e-mail message.

### DETAILED DESCRIPTION OF THE INVENTION

One embodiment of the present invention provides a method in which an e-mail message to be sent is obtained along with an e-mail distribution list containing prospective recipients of the e-mail message. A subject matter type of the e-mail message to be sent is identified. One or more user attributes are obtained for each prospective recipient. A set of predefined exclusions are referenced that associate the user attributes with the subject matter types, to identify any of the prospective recipients from the e-mail distribution list that are excluded by the subject matter type of the e-mail message to be sent. The e-mail message may then be sent to the e-mail distribution list except for the prospective recipients that are excluded by the subject matter type of the e-mail message.

Another embodiment of the present invention provides a computer program product including computer usable program code embodied on a computer usable medium for screening an e-mail distribution list. The computer program product includes computer usable program code for obtaining an e-mail message to be sent and an e-mail distribution list containing prospective recipients of the e-mail message; computer usable program code for identifying a subject matter type of the e-mail message to be sent; computer usable program code for obtaining one or more user attributes for each prospective recipient; computer usable program code defining a set of exclusions associating user attributes with subject matter types; computer usable program code for referencing the set of exclusions to identify any prospective recipients from the e-mail distribution list that are excluded by the subject matter type of the e-mail message to be sent; and computer usable program code for sending the e-mail message to the e-mail distribution list except for the prospective recipients excluded by the subject matter type of the e-mail message.

Yet another embodiment of the present invention provides a system including an e-mail client for creating an e-mail message to be sent and for selecting an e-mail distribution list containing prospective recipients of the e-mail message. A subject matter database contains a set of predefined subject matter types. A user database associates one or more user attributes with each of the prospective recipients. An exclusions database defines a set of exclusions uniquely associating each user attribute with one of the subject matter types. A screening module comprises control logic for referencing the exclusions database and sending the e-mail message to the e-mail distribution list except for the prospective recipients excluded by the subject matter type of the e-mail message.

Systems and methods are disclosed for screening prospective recipients on a distribution list to verify that the content of an e-mail message is appropriate for each prospective recipient. In one embodiment, the e-mail message and distribution list are provided to a computer, such as an e-mail server, with special screening software in accordance with the present invention prior to sending the e-mail message to the users on the distribution list. The distribution list may contain a large number of prospective recipients, wherein each prospective recipient has user information stored in a user database on the e-mail server. The distribution list can be vetted against a set of exclusionary rules (i.e. exclusions) that associate user attributes with different subject matter types. The exclusionary rules are applied to each prospective recipient in the distribution list to verify whether the content of the e-mail message is appropriate for that recipient. If a rule applies to a particular user in view of the subject matter of the e-mail message, then that particular user may be at least temporarily excluded from receiving the e-mail message. The sender or administrator may be automatically notified of the potential conflict, allowing the sender or administrator an opportunity to then individually verify whether the e-mail message should be sent to that particular user. This verification step helps prevent an e-mail message from being sent to the wrong users, such as in the event that the person creating the e-mail message selects the wrong distribution list, or helps prevent an email message from being sent to one or more users who should not be in the selected distribution list.

In the discussion that follows, the context of university admissions is applied by way of example. In that context, the system and method may prevent a congratulatory e-mail message from being sent to students who have previously received rejection letters, which can occur if the person creating the e-mail message inadvertently adds a distribution list for rejected students instead of a distribution list for accepted students. It should be understood that the inventive principles may be applied in other contexts in which bulk distribution lists are suitable, and to other types of organizations such as businesses, hospitals, and so forth. Desirably, this process is performed before the e-mail message is sent, and does not rely on any e-mail filters that may be on the recipients' individual computers after the e-mail message is sent.

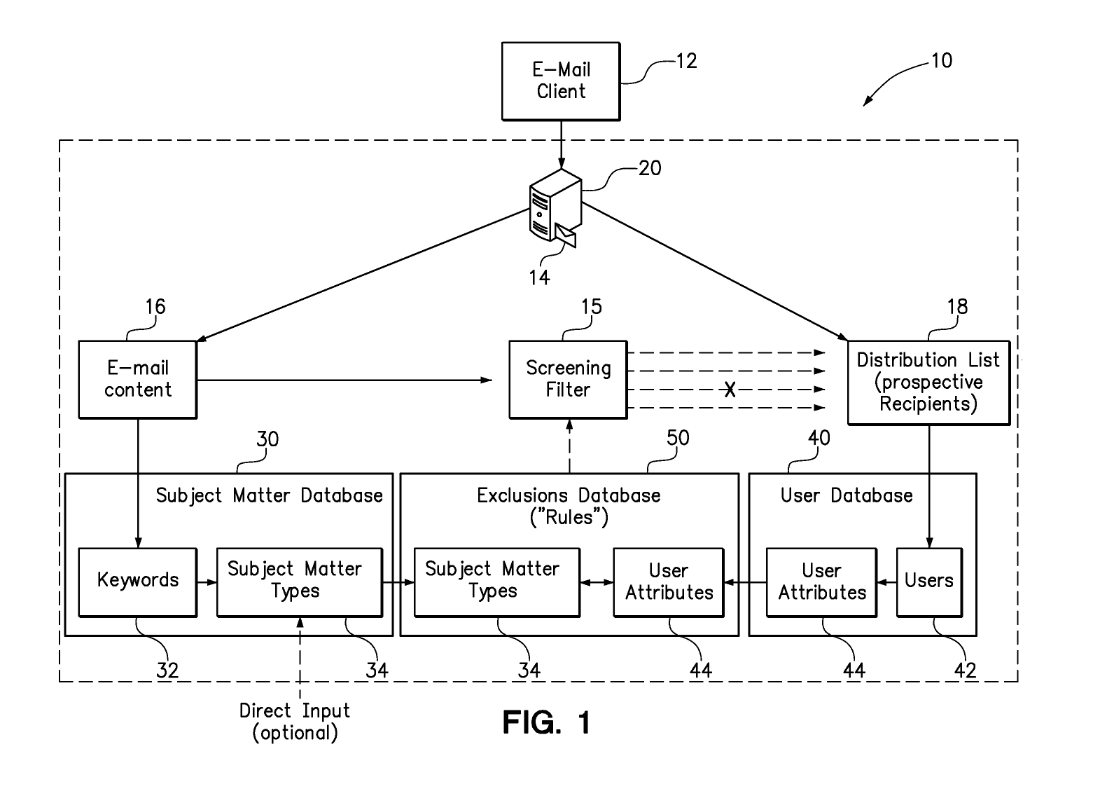

FIG. 1 is a schematic diagram of an e-mail screening system 10 for automatically screening a distribution list 18 in view of the content 16 of an outgoing e-mail message 14 before sending the e-mail message 14. The e-mail message 14 may be created by an e-mail client 12 that is included with the system 10 or interfaces with the system 10 over a network, such as a wireless network, a local area network (LAN), or the Internet. The e-mail client 12 may include functions for creating the content 16 of the e-mail message and specifying recipients of the e-mail message 14. The function of specifying recipients includes the option to attach, embed, or otherwise select the predefined distribution list 18, which may have any number of prospective recipients. The distribution list 18 may be selected from a plurality of predefined distribution lists. Embodiments of an e-mail screening system may generally include a computer with a software package comprising control logic modules and data to screen the selected distribution list 18 in view of the content 16 of the outgoing e-mail message 14. In the embodiment of FIG. 1, the software package of the system 10 resides on an e-mail server 20, although the system 10 may alternatively comprise a stand-alone software package or an optional “plug-in” software component of the e-mail client 12. The data and control logic modules of the software package comprise a subject matter database 30, a user database 40, an exclusionary rules database 50, and a screening module 15. The subject matter database 30, user database 40, and exclusionary rules database 50 that reside on the e-mail server 20 in this embodiment could alternatively reside at another location external to, and accessible by, the e-mail server 20. The screening module 15 references the exclusionary rules database 50 to selectively exclude prospective recipients from being sent an email message based on a comparison of the user attributes 44 of the prospective recipients with the subject matter type 34 of the e-mail message 14.

The e-mail content 16 is a component of the e-mail message 14 that may include the text of a message body and/or the text of a subject header. The distribution list 18 may specify a particular subset of users 42 having records in the user database 40. When the distribution list 18 is attached, embedded or otherwise selected for the e-mail message 14, the users specified in the distribution list 18 are the prospective recipients of the e-mail message 14. The distribution list 18 may be dynamically-created, and may thus change over time as users are added to or removed from the distribution list 18. For instance, the distribution list 18 may be a continually updated list of students of a school, employees of a company, members of an organization, or applicants to the school, company, or other organization. The prospective recipients specified in the distribution list 18 may include or point to e-mail addresses in the user database 40. For example, a user Jane Doe included in the distribution list 18 and having a record in the user database 40 may have an e-mail address of J.Doe@XYZ-Domain.com. The distribution list 18 may contain a large number, such as hundreds or thousands of prospective recipients.

The various databases provided on the e-mail server 20 define associations between entities that are used in screening the distribution list 18 in view of the e-mail content 16. The subject matter database 30 associates keywords 32 with subject matter types 34. The user database 40 associates the set of users 42 with user attributes 44. The exclusions database 50 associates the subject matter types 34 from the subject matter database 30 with the user attributes 44 from the user database 40. In particular, the exclusions database 50 defines the set of exclusionary rules (i.e. the exclusions) invoked by the screening module 15 for excluding prospective recipients from receiving the e-mail message 14 based on the associations between the subject matter types 34 and the user attributes 44. The exclusions database 50 may be embodied as tabular data contain copies of the subject matter types 34 from the subject matter database 30 in one column and user attributes 44 from the user database 40 in another column. Alternatively, the exclusions database 50 may simply reference the subject matter types 34 that exist in the subject matter database 30 and the user attributes 44 that exist in the user database 40. In screening the distribution list 18 for the e-mail message 14, a prospective recipient having a particular user attribute is excluded from receiving an e-mail message having a particular subject matter type if the exclusions database 50 defines an exclusion specifically associating that particular user attribute with that particular subject matter type.

Before sending the e-mail message 14 to anyone in the distribution list 18, the screening module 15 on the e-mail server 20 identifies the subject matter type of the content 16. The subject matter type of the e-mail message may be matched with or selected from any of a plurality of predefined subject matter types. In the context of a university admissions department, examples of subject matter types of e-mail messages that may be generated by that department may include “congratulations notice,” “new student orientation,” “decline notice,” “incomplete application,” “wait list,” and so forth. The system 10 may analyze the e-mail content 16 to identify any particular keyword(s) 32 and, referencing the subject matter database 30, may identify any particular subject matter type(s) 34 associated with the identified keywords 32. The keywords associated with a particular subject matter type may or may not include words used in the name of that particular subject matter type. For instance, the keywords “congratulations” or “welcome” may be associated with the subject matter type “congratulations notice,” and the keywords “incomplete application” or “please supply missing information” may be associated with the subject matter type “incomplete application.” In an alternative implementation, the subject matter type of a particular e-mail message 14 may be manually entered by a person creating the e-mail message 14.

The screening module 15 also obtains one or more user attributes 44 for each prospective recipient. The user attributes 44 may contain text descriptions regarding the status of the users 42. In the context of a school, company, or other organization, a user attributes 44 more particularly may describe or represent a user's status with respect to that organization, such as “applicant” (i.e. the user has applied for admission with a pending admission decision to a school, or to a business or other organization), “current student” (i.e. the user has previously applied and been admitted), or “alumnus” (i.e. the user is a former student who has graduated). The user database 40 may associate one or more user attribute 44 with each user 42. These predefined associations may be individually created as users 42 are added to the user database 40, such as to create a new user on the basis of an admission application and initially mark that user as “applicant.” The entity (e.g., the university) may use the user database 40 to track applicants, and information in the user database 40 may be used in applying the exclusionary rules 50. In the context of university admissions, the user database 40 may include information such as first and last name, e-mail address, current admissions status, year of admission, and so forth for each user. The user database 40 can also be set up to include fields that track that certain admissions, rejection, or orientation e-mail messages have already been sent to specific users, which may inform the set of user attributes.

Having identified a subject matter type 34 of the e-mail message 14 to be sent, and having obtained one or more user attributes 44 for each prospective recipient in the distribution list 18, the screening module 15 may then apply its control logic to reference the exclusions database 50 for the purpose of identifying any exclusionary rules that would apply. For each prospective recipient, an exclusion would apply if the exclusionary rules database 50 contains a predefined association between a particular subject matter type 34 of the e-mail message 14 and a user attribute 44 associated with that prospective recipient. To facilitate human interaction with the system 10, an exclusionary rule may be stated on an electronic user interface using a human language sentence or phrase, such as “Do not send acceptance letters to recipients if their acceptance status is PENDING or NOT APPROVED.” In this example, the exclusionary rule may associate a subject matter type of “acceptance letter” with the user attributes of “pending” or “not approved.” Note that the statement of the exclusionary rule may be alternately phrased as “Do not send acceptance letters to recipients unless their acceptance status is APPROVED,” with the same effect of excluding students who are not approved from receiving the e-mail message.

The screening process may be applied to the prospective students in sequence or in parallel. For each prospective recipient, the system 10 may reference the user database 40 to obtain the one or more user attributes 44 associated with that user 42, and reference the exclusions database 50 to whether an exclusionary rule exists for the identified subject matter type and user attribute 44. If such an exclusionary rule exists, then that user is excluded from receiving the e-mail message 14. The system 10 may process all of the prospective recipients per the screening module 15 to determine which (if any) of them are excluded, and at the conclusion of the process, send the e-mail message 14 to everyone on the distribution list 18 except for the user(s) who have been excluded. Alternatively, the system 10 may process the prospective recipients individually, and send the e-mail message 14 after a subset of excluded recipients have been determined.

When an exclusion has been identified that is applicable to a particular user, the sending of the e-mail message 14 to that user is optionally postponed or sequestered until an administrator can review the specifics of why the exclusion was applied, and take an administrator action. The administrator action upon reviewing the specifics of the exclusion may be to manually approve or deny the transmission of the e-mail message to that (at least temporarily) excluded recipient. The administrator action may also include editing the user database 40 or the distribution list 18. For example, the administrator may remove the user from the distribution list 18 if the administrator determines that the user does not belong on the distribution list or that the user otherwise should not receive the e-mail message 14. Alternatively, if the administrator determines the user should receive the e-mail message 14, the administrator may remove the relevant user attribute 44 from the user database 40 that was used to associate that user with the identified exclusion. The administrator may also manually override the exclusion in instances where the administrator determines the user should have the information in the e-mail message even though the user would normally be excluded.

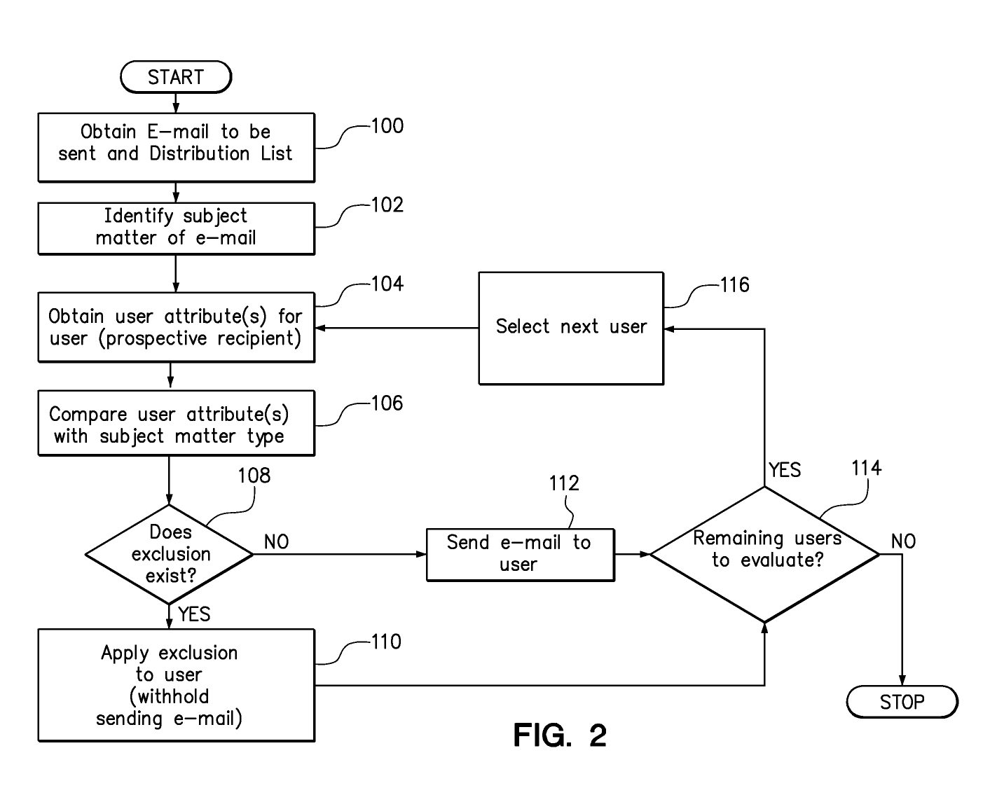

FIG. 2 is a flowchart generally outlining a method of screening a distribution list prior to sending an e-mail message in order to selectively exclude prospective recipients from being sent the e-mail message. Step 100 obtains an e-mail message to be sent along with a distribution list to which the e-mail message is to be sent. The distribution list identifies a set of “users”, which are the prospective recipients of the e-mail message. In step 102, the subject matter of the e-mail message is identified, such as determining one of a plurality of subject matter types that may apply to the e-mail message. The subject matter type(s) may be obtained from a set of predetermined subject matter types by identifying keywords in the e-mail message that are associated with the predefined subject matter types. User attributes for the prospective recipients are obtained in step 104. The user attributes may be included in a user database that associates the individual users with relevant user attributes.

A loop outlined in the flowchart starts at step 104. The loop is provided to emphasize that each user may be screened according to user attributes of that user in comparison with the subject matter type of the e-mail message to be sent. However, the prospective recipients may instead be evaluated in parallel. Step 106 compares the user attributes obtained for a particular user in step 104 with the subject matter type identified in step 102. Conditional step 108 determines whether a predefined exclusionary rule (i.e. an “exclusion”) exists associating the user attribute(s) of the prospective recipient currently under evaluation with the subject matter type of the e-mail message. If such an exclusion exists, then the exclusion is applied to that prospective recipient in step 110, to at least temporarily withhold sending the e-mail message to user (prospective recipient) currently under evaluation. If no such exclusion exists for that prospective recipient, then the e-mail message will be sent to that user per step 112. The e-mail message may be sent at any time after it is determined that no exclusion exists for this prospective recipient. Optionally, all of the users in the distribution list may first be evaluated, after which the e-mail message may be sent to all non-excluded users at the same time.

Conditional step 114 is performed iteratively according to the loop to determine whether there are users remaining in the distribution list who still need to be evaluated for the existence of exclusions. If so, then the next user to be evaluated is selected from the distribution list per step 116, and the process returns to obtaining the user attribute(s) for that user (step 104), comparing the user attribute(s) to the subject matter type of the e-mail message (step 106) to determine whether an exclusion exists for that user (step 108). Again the users may be evaluated sequentially, as outlined, or in parallel, for any number of users (e.g. hundreds or thousands of prospective recipients) on the distribution list.

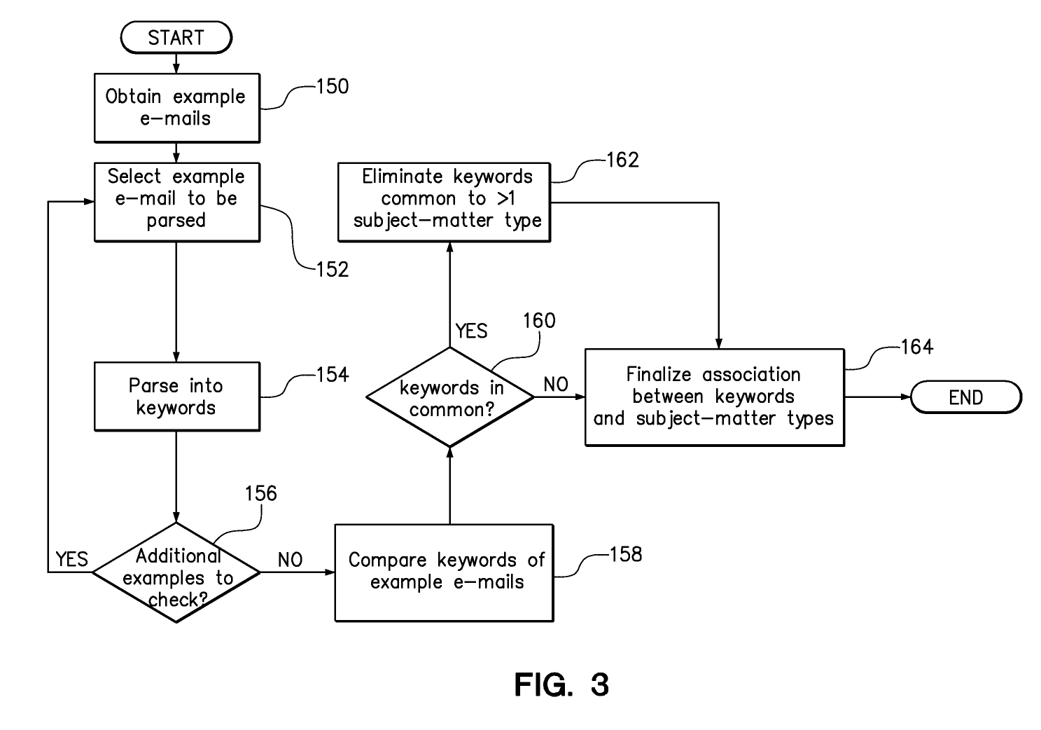

FIG. 3 is a flowchart outlining an example method for generating subject matter types for characterizing e-mail messages. The method outlined in FIG. 3 may be performed prior to performing the screening method of FIG. 2. Step 150 obtains some example e-mail messages, which may be manually selected by an administrator. The example e-mail messages may each relate to a different topic or subject matter type. The subject matter types (e.g. congratulations notice, new student orientation, decline notice, incomplete application, wait list, etc.) may be individually selected and applied to the example e-mail messages by an administrator. In the context of university admissions, for example, the example e-mail messages may include an acceptance letter, a rejection letter, an incomplete application notice, a waiting list notice, or information about a new student orientation. Step 152 selects one of the example e-mail messages to be evaluated, and step 154 parses the selected example e-mail message into keywords. Conditional step 156 sets up a loop whereby additional example e-mail messages may be evaluated and parsed into keywords. Note that a plurality of example e-mails may be used for each subject matter type to potentially build a larger set of words associated with each subject matter type. For example, the software may evaluate many examples of acceptance letters from the last several years to obtain multiple keywords and phrases associated with that subject matter type. One acceptance letter may use the keyword “congratulations” and another acceptance letter may use the keyword/phrase “pleased to inform you,” and both of these could be added to the set of keywords for that subject matter type.

After all of the example e-mail messages have been parsed into keywords, an additional subroutine may be performed to ensure that each subject matter type is associated with a unique set of keywords. Step 158 compares the keywords of the example e-mail messages. Conditional step 160 then checks whether any of the example e-mail messages had common keywords. If there are any keywords common to different subject matter types, step 162 eliminates those keywords to ensure a unique set of keywords for each subject matter type. Step 164 then associates the set of keywords from each example e-mail message with the subject matter type selected for that example e-mail message.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining an e-mail message to be sent and an e-mail distribution list containing prospective recipients of the e-mail message;
identifying a subject matter type of the e-mail message to be sent;
obtaining one or more user attributes for each prospective recipient;
referencing a set of predefined exclusions associating user attributes with subject matter types, to identify any prospective recipients from the e-mail distribution list that have a user attribute that the set of predefined exclusions associate with the subject matter type of the e-mail message to be sent; and
sending the e-mail message to the e-mail distribution list except for the prospective recipients identified using the set of predefined exclusions.

2. The method of claim 1, wherein identifying the subject matter type of the e-mail message to be sent comprises:
obtaining one or more example e-mail messages for each of the plurality of subject matter types;
parsing each example e-mail message into one or more keywords and associating the one or more keywords with the subject matter type; and
matching the content of the e-mail message to be sent to the keywords in the example e-mail messages to identify the associated subject matter types.

3. The method of claim 2, further comprising:
after parsing each example e-mail message into one or more keywords, eliminating any keywords common to more than one subject matter type from the association with subject matter types, so that each keyword is associated with only one of the plurality of subject matter types.

4. The method of claim 1, further comprising:
looking up each prospective recipient in a user database and obtaining the one or more user attributes for each prospective recipient from the user database.

5. The method of claim 1, further comprising:
obtaining one or more keywords from the e-mail message to be sent and looking up the keywords in a subject matter database to identify the subject matter type of the e-mail message to be sent.

6. The method of claim 1, further comprising:
the one or more user attributes comprise an admission status;
the identified subject matter type of the e-mail message is associated with admission status; and
one of the predefined exclusions excludes a prospective recipient with a particular value of admission status from receiving the e-mail message to be sent.

7. A computer program product including computer usable program code embodied on a computer usable medium for screening an e-mail distribution list, the computer program product including:
computer usable program code for obtaining an e-mail message to be sent and an e-mail distribution list containing prospective recipients of the e-mail message;
computer usable program code for identifying a subject matter type of the e-mail message to be sent;
computer usable program code for obtaining one or more user attributes for each prospective recipient;
computer usable program code defining a set of exclusions associating user attributes with subject matter types;
computer usable program code for referencing the set of exclusions to identify any prospective recipients from the e-mail distribution list that are excluded by the subject matter type of the e-mail message to be sent; and
computer usable program code for sending the e-mail message to the e-mail distribution list except for the prospective recipients excluded by the subject matter type of the e-mail message.

8. The computer program product of claim 7, wherein the computer usable program code for identifying the subject matter type of the e-mail message to be sent comprises:
computer usable program code for parsing each of a plurality of example e-mail messages into one or more keywords and associating the one or more keywords with the subject matter type; and
computer usable program code for matching the content of the e-mail message to be sent to the keywords in the example e-mail messages to identify the associated subject matter types.

9. The computer program product of claim 8, further comprising:
computer usable program code for eliminating any keywords common to more than one subject matter type so that each keyword is uniquely associated with only one of the plurality of subject matter types.

10. The computer program product of claim 7, further comprising:
computer usable program code defining a user database associating one or more user attributes with each of a plurality of users; and
computer usable program code for looking up each prospective recipient in the user database to obtain the one or more user attributes for each prospective recipient.

11. The computer program product of claim 7, further comprising:
computer usable program code defining a subject matter database associating one or more keywords with each of a plurality of keywords; and
computer usable program code for obtaining one or more keywords from the e-mail message to be sent and looking up the keywords in the subject matter database to identify the subject matter type of the e-mail message to be sent.

12. The computer program product of claim 7, further comprising:
the one or more user attributes comprise an admission status;
the identified subject matter type of the e-mail message is associated with admission status; and
one of the predefined exclusions excludes a prospective recipient with a particular value of admission status from receiving the e-mail message to be sent.
